(19) United States
(12) Patent Application Publication
(10) Pub. No.: US 2015/0363735 A1
(43) Pub. Date: Dec. 17, 2015

(54) TRACKING CUSTOMER INTERACTIONS FOR A BUSINESS

(71) Applicant: Vivint, Inc., Provo, UT (US)

(72) Inventor: Greg Fairbanks, Cedar Hills, UT (US)

(21) Appl. No.: 14/304,768

(22) Filed: Jun. 13, 2014

(51) Int. Cl. G06Q 10/06; H04N 7/18

(52) U.S. Cl. CPC G06Q 10/06393; H04N 7/18

(57) ABSTRACT

A computer-implemented method to track customer interactions for a business is described. Movement of a customer at location associated with the business is tracked. At least one interaction between the customer and at least one personnel associated with the business is determined based at least in part on the tracking. The quality of the at least one interaction may be rated based at least in part on the determining.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to the computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of technology in everyday life. Advancements in mobile devices and related mobile technology allow users to monitor their location, movement, and/or other aspects of everyday life. As technology expands into homes and businesses, opportunities exist for using technology for alternative purposes such as tasks related to rating customer experiences and interactions with a business.

### SUMMARY

According to at least one embodiment, a computer-implemented method to track customer interactions for a business is disclosed. The method may comprise tracking movement of a customer at location associated with the business. The method may comprise determining at least one interaction between the customer and at least one personnel associated with the business based at least in part on the tracking. The quality of the at least one interaction may be rated based at least in part on the determining. In some embodiments, the at least one personnel interacting with the customer may be identified based on the determining and the at least one personnel may be rated based on the quality of the interaction between the personnel and the customer. In some embodiments, a supervisor of the personnel may be alerted when the personnel rating does not meet a threshold. In some embodiments, the interaction may comprise the customer requesting help from the at least one personnel. In further embodiments, the interaction may comprise the at least one personnel completing a customer purchase.

In some embodiments, the movement of the customer may be captured via a video feed. The customer enter and exit times at the location associated with the business may be determined based at least in part on the determining. A total length of time the customer was present at the business location may be calculated. In some embodiments, it may be determined if the customer made a purchase. The customer purchase may be linked to a video of the customer. The customer experience may be additionally rated based at least in part on the total length of time the customer was at the business location and the customer purchase. In some embodiments, the video feed may be displayed on a dashboard associated with the business. The dashboard may be accessible via a mobile computing device.

In alternative embodiments, the customer may be assigned a unique identifier. The rating associated with the customer may be recorded based on the unique identifier and a profile associated with the customer may be generated based at least in part on the rating and the unique identifier. The unique identifier may be one of a loyalty card number, a credit card number, a phone number, an email, or a name. In some embodiments, the purchases made by the customer may be observed and recorded based on the unique identifier. Marketing material may be generated unique to the customer based on the recording. In some embodiments, at least one personnel associated with the business may be notified when a customer interaction rating falls below a threshold.

According to another embodiment, an apparatus to automate scheduling for a business is also described. The apparatus may include a processor, a memory in electronic communication with the processor and instructions stored on the memory of the processor. The processor may execute the instructions to track movement of a customer at location associated with the business. The instructions may be executable by the processor to determine at least one interaction between the customer and at least one personnel associated with the business based at least in part on the tracking. The instructions may be executable by the processor to rate the quality of the at least one interaction based at least in part on the determining.

According to another embodiment, a computer-program product to automate scheduling for a business is also disclosed. The computer-program product may include a non-transitory computer-readable medium that may store instructions executable by a processor. The instructions may track movement of a customer at location associated with the business. The instructions may determine at least one interaction between the customer and at least one personnel associated with the business based at least in part on the tracking. The instructions may rate the quality of the at least one interaction based at least in part on the determining.

The foregoing has outlined rather broadly the features and technical advantages of examples according to the disclosure such that the following detailed description may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of an example of another environment in which the present systems and methods may be implemented;

FIG. 3 is a block diagram of an example automated scheduling module of the environments shown in FIGS. 1 & 2;

FIG. 4 is a block diagram of an example scheduling module of the environment shown in FIG. 3;

FIG. 5 is a block diagram of an example customer module of the environments shown in FIGS. 1 & 2;

FIG. 6 is a flow diagram illustrating a method to automate scheduling for a business;

FIG. 7 is a flow diagram illustrating another method to automate scheduling for a business;

FIG. 8 is a flow diagram illustrating an exemplary method of finding auxiliary personnel;

FIG. 9 is a flow diagram illustrating an exemplary method of tracking customer interactions;

FIG. 10 is a flow diagram illustrating another exemplary method of tracking customer interactions;

FIG. 11 is a block diagram of a computer system suitable for implementing the present systems and methods of FIGS. 1-10;

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to automated customer rating systems. More specifically, the systems and methods described herein relate to an automated system for rating a quality of interactions a customer may have with one or more personnel associated with a business. The quality rating may be based at least in part on the interactions, a length of time spent in the store, or purchases made by the customer. In one example, customer data may be observed and recorded including at least unique identifier associated with the customer, a quality rating, an overall customer value rating, and the like. In another embodiment, personnel may be alerted if a quality rating satisfies thresholds or parameters.

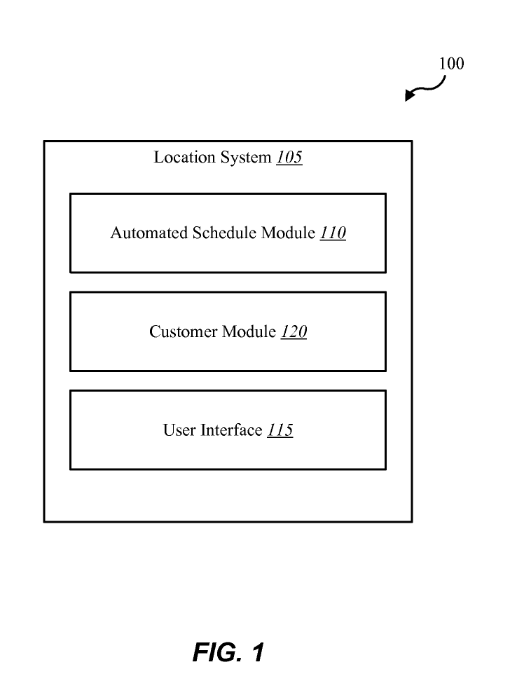

FIG. 1 is a block diagram illustrating one environment 100 on which the methods and disclosure may be implemented. The environment 100 may include a location system 105. The location system 105 may include an automated schedule module 110, a customer module 120, and a user interface 115. While FIG. 1 shows the automated schedule module 110, the customer module 120, and the user interface 115 included within the location system 105, these and other components of the environment 100 may be housed separately and operate independently while still working cooperatively with each other and other components of the location system 105.

The location system 105 may be associated with a commercial entity. For example, the location system 105 may be located at a business. The business may have at least one personnel associated with it. In some embodiments, the personnel may be an employee. The business may be any commercial business. In some instances, the business may be a restaurant, a retailer, a warehouse, a health-care provider, a law firm, an accounting firm, a service provider, and the like. In some instances, a location system 105 may be present at multiple different locations associated with the same business. For example, the business may be part of chain, may have satellite offices, or the like. In other examples, the business may have multifunctional locations. For example, a business may have a warehouse, a manufacturing facility, an office space, a testing space and/or any combination thereof. In those embodiments, the environment 100 may have multiple location systems 105 for each business location. In other embodiments, one location system 105 may be present at a single location and may service all of the business's locations. When the term business is used herein, it encompasses all types of non-residential locations.

The location system 105 may be controlled by an administrator. The administrator may be a supervisor, personnel, business owner, CEO, employee, or some other professional associated with the location. In some embodiments, multiple people may be the administrator. For purposes of clarity, the term administrator used herein may encompass either a single individual or multiple individuals with equal access to the location system 105, personnel scheduling duties, and access to business metrics.

The automated schedule module 110 may be configured to observe and learn from the actions of personnel associated with the business and to create a schedule optimized for business needs. In some embodiments, personnel may interact with scheduling system via a mobile device. For purposes of clarity, personnel may refer to single personnel or multiple personnel. Personnel may include full or part-time employees, contractors, temporary workers, seasonal workers, apprentices, interns, trainees and the like. Additionally, the term supervisor may encompass a supervisor, business owner, administrator, supervisor, or any personnel in charge of staffing solutions and capable of accessing business metrics. While the term supervisor will be used, it will be understood that it may encompass multiple supervisors.

In some embodiments, the automated schedule module 110 may be a mostly automated system requiring little to no external input. In other embodiments, the automated schedule module 110 may receive varying levels of input to shape and customize the automated schedule module 110 to meet the business needs. The user interface 115 may interact with the automated schedule module 110 and receive supervisor preferences, personnel preferences, business information and the like. In other embodiments, the user interface 115 may be integrated with the personnel's device or a supervisor's device.

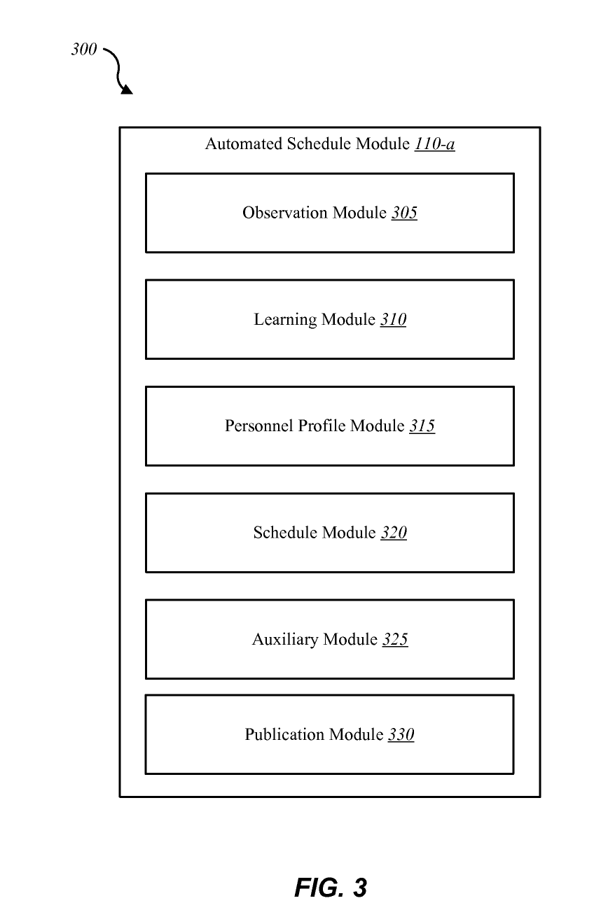

The automated schedule module 110, in addition to automating a work schedule, may have the capability to store and analyze personnel data, track business efficiency and profitability and other functions as described in further detail below with reference to FIG. 3. The automated schedule module 110 may also be capable of receiving communications from a remote device in response to the work schedule. The automated schedule module 110 may perform additional functions as discussed herein.

In some embodiments, the customer module 120 may be a mostly automated system requiring minimal input, or in some instances, may be a completely independently operational module. In some embodiments, the customer module 120 may interface with a security system located onsite at a business location. In further embodiments, the customer module 120 may additionally track and contribute to a personnel rating. In some embodiments, the customer module 120 may allow a supervisor to determine which metrics are tracked and set thresholds or parameters for alerting the supervisor. In additional embodiments, the alerts may be preprogrammed which may set the thresholds or parameters to trigger the alerts.

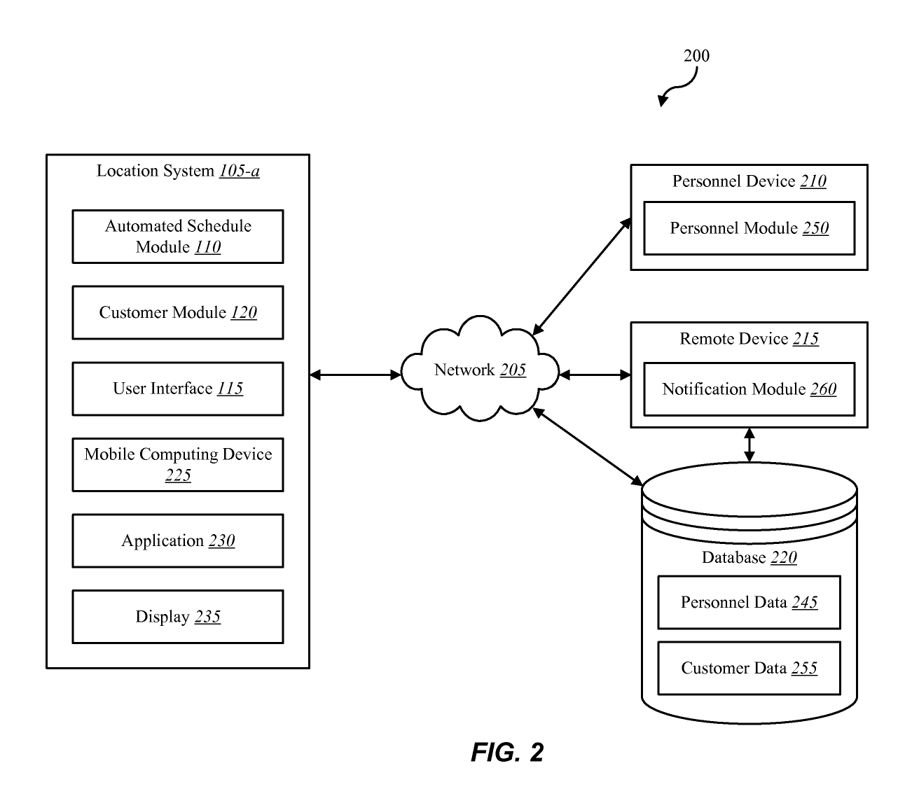

Referring now to FIG. 2, in some embodiments, an environment 200 may include the components of environment 100 described above, and may further include a network 205, a personnel device 210, a remote device 215, and a database 220. The location system 105-a may be one example of the location system 105 described above with reference to FIG. 1. The location system 105-a may include, in addition to the automated schedule module 110, the customer module 120, and the user interface 115, a mobile computing device 225, an application 230, and a display 235. A database 220 may include (e.g., store) personnel data 245 and/or customer data 255.

The location system 105-a may include various components and functionalities that work cooperatively with the automated schedule module 110, the customer module 120, and the user interface 115, and/or may operate independently of the automated schedule module 110, the customer module 120, and the user interface 115. In some embodiments, the application 230 may use the location system 105-a to perform tasks related to the automated schedule module 110 and/or the customer module 120.

In some embodiments, the mobile computing device 225 may include one or more processors, one or more memory devices, and/or a storage device. Examples of the mobile computing device 225 may include mobile computing devices, smartphones, personal computing devices, computers, servers, etc. The mobile computing device 225 may be operable independent of features of the automated schedule module 110, the customer module 120 and the user interface 115. Alternatively, at least some functionality of the mobile computing device 225 may cooperate with and/or interface with the automated schedule module 110, the customer module 120, and/or the user interface 115.

The application 230 may allow a user or supervisor to control (either directly or indirectly) an aspect of the property where the location system 105-a is located. In some configurations, the application 230 may also interface between, for example, the automated schedule module 110, the customer module 120, the user interface 115, the mobile computing device 225, or the display 235. Thus, the application 230, via the user interface 115, the display 235, and/or the mobile computing device 225, may allow supervisors to automate customer interaction ratings. Information or data associated with the application 230 and its operation may be saved according to the data storage methods described herein.

In some embodiments, a user may access the functions of the location system 105-a from the mobile computing device 225. For example, in some embodiments, the mobile computing device 225 includes a mobile application that interfaces with one or more functions of the location system 105-a (e.g., automated schedule module 110/customer module 120). Examples of the mobile computing device 225 may include a personal computing device (e.g., a laptop, desktop, etc.), a mobile computing device (e.g., tablet computing device, smartphone, etc.), and the like. The automated schedule module 110, the customer module 120, and/or the user interface 115 may be integrated with the mobile computing device 225 in the form of one or more personal computing devices (e.g., mobile devices, smartphones, and/or personal computing devices) to control aspects of the location and/or monitor activities of personnel (e.g., clock-in, clock-out, perform duties, job performance, scheduling, receive business metric alerts, etc.).

In some embodiments, the personnel device 210 may be a mobile device unique to a particular personnel. The personnel device 210 may include, for example, a personal computing device (e.g., laptop), a mobile computing device (e.g., tablet computing device, smartphone, etc.), a wearable device, a multi-purpose portable device, a multi-purpose pocket computer, or the like. The personnel device 210 may be in communication with the automated schedule module 110, the customer module 120, or other features and components of the location system 105-a via, for example, the network 205. The personnel device 210 may be capable of two-way communication with the automated schedule module 110, the customer module 120, and other features of the location system 105-a including, for example, receiving notifications from and sending information (e.g., notifications, time entry information, schedule information, auxiliary shift options, etc.) back to the automated schedule module 110, the customer module 120, or other features of the location system 105-a. The personnel device 210 may include a display and/or user interface. Notifications may be received on the personnel device 210 in the form of, for example, a text message, email, audible signal, picture, ping message, etc. The notifications received at the personnel device 210 may be in response to scheduling data which is generated via the automated schedule module 110, the customer module 120, and/or the user interface 115 and delivered to the remote device 215 and/or the database 220, or directly to the personnel device 210. The personnel device 210 may also include storage capability to store data such as personnel work data, notifications, schedules, contact information, personnel ratings, and the like associated with their employment.

In some embodiments, the personnel device 210 may interact with the location system 105-a via a personnel module 250. The personnel module 250 may be configured to receive a work schedule from the automated schedule module 110 and/or the customer module 120. The personnel module 250 may also interact with the automated schedule module 110 and send information such as sick time, vacation days, and the like. In further embodiments, the personnel module 250 may enable personnel to confirm auxiliary staff. The personnel module 250 may also enable personnel to receive notifications of upcoming shifts, interactions with the supervisor, and other information relating to the business. In some embodiments, the personnel module 250 may interact and receive alerts from the customer module 120. For example, the personnel module 250 may receive quality interaction ratings from the customer module 120 or may send and receive other alerts and/or message from the customer module 120.

In some embodiments, the remote device 215 may also communicate with the automated schedule module 110, the customer module 120, and other features and components of the location system 105-a via, for example, the network 205. The remote device 215 may be any of a number of electronic devices including, for example, a dedicated automation computing device (e.g., wall-mounted controller), a personal computing device (e.g., laptop, desktop, etc.), a mobile computing device (e.g., a tablet computing device, smartphone, etc.), and the like. The remote device 215 may be located physically away from the location system 105-a or components thereof such as, for example, the user interface 115. The remote device 215 may be accessed by, for example, a supervisor or other personnel associated with the place of business. The remote device 215 may be configured for two-way communication with the automated schedule module 110, the customer module 120, and other features of the location system 105-a. The remote device 215 may receive notifications and information associated with personnel, customers, scheduling, and the like (e.g., personnel data, work schedule, auxiliary staffing data, abnormal customer data, etc.). For example, the remote device 215 may contain a notification module 260. The notification module 260 may be configured to exchange alerts and/or message with the customer module 120. For example, the notification module 260 may receive alerts relating to customer data, scheduling parameters, inventory parameters, customer ratings, and the like.

The personnel data 245 may be accessed directly from the database 220, from the personnel device 210 via, for example, the network 205 and/or the automated schedule module 110, the customer module 120, or other components of the location system 105-a. The personnel data 245 may be in the form of raw data such as, for example, staffing requirements, personnel profiles, personnel ratings, and/or historical profit information. For example, the personnel profile may include information such as role, pay scale and a score associated with personnel. The personnel data 245 may also include more detailed information. For example, it may include staffing schedules and may record the punctuality, reliability, and performance of the personnel. In some instances, select personnel may be habitually late and constantly calling in sick. The personnel data 245 may record each instance and use the information to generate a score associated with the personnel. The personnel data 245 may also include information regarding performance. For example, the personnel may be consistently improving and taking on new roles at the business. The personnel may additionally cause an increase in sales or customer satisfaction. For example, the personnel may consistently receive positive customer interaction ratings.

In further embodiments, the customer data 255 may be accessed directly from the database 220, from the personnel device 210 via, for example, the network 205 and/or the automated schedule module 110, the customer module 120, or other components of the location system 105-a. The customer data 255 may be in the form of raw data such as, for example, customer purchases, customer movement, customers entering and exiting the business, and/or historical customer information. The customer data 255 may also include more detailed information. For example, it may store data relating to number of customers onsite, online purchases, correlation between personnel and customer business, or the like. The customer data 255 may also store video feed tracking customer interactions at a business location. In some embodiments, the customer data 255 may be organized according to a unique identifier associated with individual customers. The customer data 255 may record historical business information such as customer data and trends. The customer data 255 may also include information correlating personnel to customer data. For example, some personnel may generate more revenue than others.

The remote device 215 may include a user interface, storage capability, and other features and functionalities that permit the remote device 215 to not only receive notifications and data, but to also send instructions, data, notifications, and the like. The remote device 215 may receive personnel profiles, staffing needs, automate a schedule, receive customer data, receive customer ratings and alerts, communicate with the location system 105-a, and/or store relevant information in a database (e.g., in database 220). The remote device 215 may also send notifications to the personnel device 210, the automated schedule module 110, the customer module 120, or other components of the location system 105-a, or to another location or remote device 215.

The network 205 provides communication via, for example, wired or wireless connections. Further, the network 205 may include a plurality of communication mediums. For example, the network 205 may include different communication mediums to provide communication between the automated schedule module 110, the customer module 120, and/or other components of the location system 105-a and other devices such as the personnel device 210, the remote device 215, and the database 220. Examples of the network 205 may include cloud networks, local area networks (LAN), wide area networks (WAN), virtual private networks (VPN), wireless networks (using 802.11, for example) and/or cellular networks (using 3G and/or LTE, for example), etc. In some embodiments, the network 205 may include the internet.

FIG. 3 is a block diagram 300 illustrating one example of an automated schedule module 110-a. The automated schedule module 110-a may be one example of the automated schedule module 110 depicted in FIGS. 1 and/or 2. As depicted, the automated schedule module 110-a may include an observation module 305, a learning module 310, a personnel profile module 315, a schedule module 320, an auxiliary module 325, and a publication module 330. Other embodiments may include additional or, in some embodiments, less modules than that which is shown in FIG. 3.

In some embodiments, the observation module 305 may observe personnel actions and scheduling. Personnel actions may include at least one of the performance, timeliness, and reliability. For example, the observation module 305 may observe clock-in and clock-out information. The observation module 305 may compare the clock-in and clock-out information with the scheduled shift times. The observation module 305 may record if the personnel is punctual, tardy, or the like. The observation module 305 may further track the consistent behavior of the personnel to note if personnel is habitually tardy or habitually punctual and may disregard sporadic tardy days for a habitually punctual personnel.

In some embodiments, the observation module 305 may also observe and/or record the performance of the personnel. For example, the personnel may cause an increase in business efficiency or sales. For example, in a restaurant business, the observation module 305 may notice a member of the wait staff consistently receives generous tips and positive feedback. In contrast, the observation module 305 may also observe a wait staff personnel who receives numerous complaints. In other embodiments, the observation module 305 may realize an increase in sales of consumer products or services associated or attributed to a particular personnel. The observation module 305 may also realize and observe advancing or improving skillset. For example, a beginner may make fewer mistakes or show a potential to increase their responsibilities.

In further embodiments, the observation module 305 may observe the reliability of personnel. For example, one or more personnel may consistently call in sick or have unscheduled emergencies and/or days off. In some instances, personnel may fail to call-in sick or otherwise notify the business of a pending absence. The observation module 305 may record the absences. For example, the observation module 305 may determine a particular personnel consistently calls in sick every third Thursday of the month. The absences may be observed and recorded to determine and may determine there is a pattern. Additionally, frequent absences may cause an alert to be sent to a supervisor.

The observation module 305 may additionally observe existing work scheduling practices. For example, the observation module 305 may observe shift start and end times, shift overlap, combinations of personnel scheduled, and the like. For example, the observation module 305 may determine the shift start and end times for specific personnel, specific roles scheduled, or a combination of both. Additionally, the shift start and end times may differ depending on day of the week, or other external factors such as seasonal changes. In some embodiments, combinations of personnel scheduled may include the different roles of the personnel scheduled and/or the actual personnel combinations that are scheduled. For example, the observation module 305 may determine the number of cashiers, wait staff, cooks, bartenders, or the like scheduled at a restaurant. The observation module 305 may also determine the specific personnel scheduled to work.

In some embodiments, the observation module 305 may compare the personnel and scheduling observations with a profit, efficiency, or other business metrics. For example, the observation module 305 may determine a specific combination of personnel roles leads to a greater profit during the scheduled shift. The specific combination of personnel may maximize efficiency while still meeting customer needs. In another embodiment, the observation module 305 may determine an increased profit or efficiency with a specific combination of personnel. The specific personnel may work more cohesively or effectively to the benefit of the business. For example, a specific combination of personnel at a construction site may work more effectively to finish the job at a faster rate, thus increasing the profits realized. The observation module 305 may also track an increase in sales when specific sales personnel work together on the sales floor.

Conversely, the observation module 305 may also determine when a combination of personnel decreases the efficiency or profitability of the business. For example, in some embodiments, a specific combination and number of personnel roles may decrease the efficiency or profitability of the business. For example, there may be too many cooks scheduled to work at a restaurant, or too many sales personnel on the sales floor. Additionally, the observation module 305 may observe when a combination of specific personnel leads to a decrease in efficiency or profitability. For example, two specific sales personnel may converse during their shift, ignoring customers. This may reflect a decrease in expected sales every time the two sales personnel are jointly scheduled. Additionally, in some instances, some personnel may have an abrasive relationship when scheduled jointly which may detrimentally affect the business. For example, two construction workers may bicker and not work cohesively to finish a building job or two line cooks may not function well together and may delay orders. The observation module 305 may observe and track this type of information.

In some embodiments, the observation module 305 may collect historical scheduling information or other information relating to the business. For example, the observation module 305 may receive information regarding historical shift scheduling, salary information, accounting information, personnel information and the like. The information may be uploaded into the observation module 305 or otherwise received and analyzed by the observation module 305. In further embodiments, the observation module 305 may collect historical information such as seasonal information, market information, or previous sales information. For example, the observation module 305 may observe market fluctuations based on external forces such as weather, world events, or the like. The observation module 305 may additionally observe and analyze previous sales information and may determine a pattern or other characteristics of pervious sales. In some embodiments, the information may be gathered and compared to other gathered data to determine correlations between work schedules, market fluctuations, seasonal impacts, and the like.

The learning module 310 may use the information from the observation module 305 to develop parameters and the like. For example, the learning module 310 may learn the scheduling needs of the business based on the observations and set forth certain parameters or rules for drafting and/or producing the work schedule and/or the shift requirements. The learning module 310 may optimize shift changes, or any necessary overlap between personnel for a cohesive business unit. Additionally, the learning module 310 may put rules in place where certain personnel are either to be scheduled together as frequently as possible or never be scheduled together.

As the learning module 310 becomes more sophisticated and refined, it may begin to implement changes. The changes may be acutely observed by the observation module 305 to determine their success or lack thereof. For example, the learning module 310 may increase or decrease staff based on a series of observations. The learning module 310 may implement this change and observe for a period of time before determining its success or failure. In some embodiments, the learning module 310 may automatically implement changes into the automated schedule module 110-a. In further embodiments, a supervisor may need to approve the changes before they are implemented. Further, the learning module 310 may only implement small, incremental changes, or may implement larger scale scheduling changes to optimize profit, efficiency, and other business metrics.

The personnel profile module 315 may record and retain profile information associated with personnel. The profile information may contain at least some information gathered by the observation module 305. For example, the personnel profile may include a score, pay scale, a role, and the like. The personnel score may track and evaluate individual personnel. The personnel score may be based at least in part on the personnel's attendance, proficiency, efficiency, profitability, timeliness, and the like. The personnel score may help the business determine the worth of the personnel and may also aid in scheduling. For example, it may not be desirable to schedule a shift consisting only of personnel with subpar ratings. Rather, it may be desirable to have a balanced number of personnel from multiple scoring levels. In further embodiments, personnel with superior ratings may receive more desirable shifts, an increased quantity in shifts, and the like. Additionally, personnel with superior ratings may receive bonuses, raises, or other forms of compensation.

In further embodiments, the personnel profile module 315 may contain pay scale information. For example, a personnel may have an hourly rate or some other quantifiable cost associated with them. This information may be stored within the personnel profile and may aid in creating a schedule. Other information which may be included in the personnel profile may include the personnel role, the proficiency of the personnel, the personnel's seniority, a profitability rating, and the like. A profitability rating may include either the ability of the personnel to make a sale, complete a job in an efficient manner, or some other quantifiable measure of profitability relating to the particulars of the business.

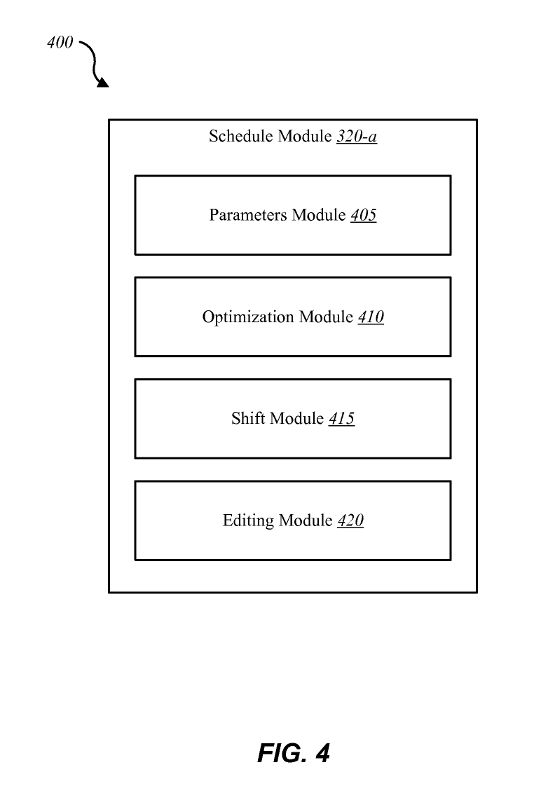

FIG. 4 is a block diagram 400 illustrating one example of a schedule module 320-a. The schedule module 320-a may be one example of the schedule module 320 displayed in FIG. 3. The schedule module 320-a may generate a work schedule for a business. The schedule may applicable to a number of industries and types of businesses or commercial locations. As depicted, the schedule module 320-a may include a parameters module 405, an optimization module 410, a shift module 415, and an editing module 420. Other embodiments may include additional or fewer capabilities than those illustrated in FIG. 4.

The parameters module 405 may be configured to set different parameters for each shift or each particular job of the business. Parameters may include minimum number of personnel, roles of personnel, profitability of the shift, and the like. The minimum number of personnel may combine with the personnel role to ensure every facet of the business is adequately staffed. For example, a business may require a number of personnel to pull supplies and then a different number of personnel to package supplies, and a third number of personnel to ship the packages. In another embodiment, a construction company may require a different number of masons, plumbers, electricians, etc. The number of each may vary depending on the size of the job, the location of the job, and the customer's parameters. In some embodiments, the time of day, or timing of the project may affect the scheduling parameters. For example, more electricians and plumbers may be needed one day, whereas the next, the business may require sheet-rockers. In other embodiments, the business may require different numbers or types of personnel depending on the time of day. For example, a restaurant/bar may require an increase in staffing during the dinner hour and then an additional increase in bartenders during the late evening, nighttime hours.

The parameters module 405 may also set rules such as specific personnel to group together or to separate. For example, the observation module 305 (FIG. 3) may determine a combination of personnel is more efficient or profitable and, conversely, another combination of personnel is detrimental to the success of the business. The parameters module 405 may set rules surrounding these individual personnel to maximize business profitability and efficiency. In some embodiments, the parameters module 405 may set a threshold for minimum personnel scheduled for each shift. The minimum personnel may be a correlation to historical information wherein the required personnel and the expected customer traffic maintains a predetermined ratio. In some embodiments, the number of customers present at the business may be tracked (e.g. by the customer movement module 505) and may be compared to the number of personnel scheduled for the shift. If the customers exceeds the expected amount, or if the ratio of personnel to customers exceeds a threshold, an alert may be sent to a supervisor of the personnel. The alert may simply notify of an upcoming expected shortage, that the ratio has been exceed, or the like. In some embodiments, the supervisor may use an auxiliary module (e.g. auxiliary module 325) to locate auxiliary personnel to supplement the needs of the business.

The parameters module 405 may also set parameters for each shift wherein the parameters include at least a required number of personnel from predetermined score ranges. For example, the learning module 310 (FIG. 3) may determine and/or set predetermined personnel score ranges. The ranges may categorize personnel such as on a 1-10 scale or may set a naming categorization such as fundamental, novice, intermediate, advanced, and expert. The parameters module 405 may then have a required mixture or threshold of personnel from the different competencies. For example, every shift may be required to have at least one expert personnel in each personnel role scheduled. Or, only certain shifts may have this requirement, for example, a restaurant may require an expert chef for the lunch and/or dinner hours but may only require an advanced or intermediate chef scheduled during the slow business hours. In additional embodiments, the parameters module 405 may set a threshold of scores for shifts. For example, a shift may require a combined score such as 50. Then the personnel for the shift must have a combined score that meets or exceeds the score of 50. For example, scheduling 5 personnel for the shift with a score of 10 would meet the threshold. Other combinations of personnel and shift requirements may also meet the combined the score. The combined score or threshold may ensure the shift is adequately staffed to support the shift needs.

In further embodiments, the parameters module 405 may identify personnel scores within a predetermined range of scores. Personnel who have scores within the predetermined range may be scheduled for preferred shifts. For example, if personnel have a score ranging from 5-10, or intermediate—expert, may submit requests for their preferred shifts. The preferred shifts may be better working hours, more profitable shifts, or the like. The parameters module 405 may set parameters to provide preferential treatment to deserving personnel.

The optimization module 410 may review the requirements set in the parameters module 405 to ensure the schedule is optimized for profitability and efficiency. For example, the optimization module 410 may ensure certain personnel are not scheduled for overtime, or the overtime is limited to a profitable range. Additionally, the optimization module 410 may review a schedule to ensure the pay-scale of the personnel scheduled is optimized for efficiency and profitability. For example, the optimization module 410 may balance the personnel score with the personnel pay-scale. By balancing pay ranges with scores, the optimization module 410 may maximize profitability or other desirable business metrics.

In further embodiments, the optimization module 410 may balance the different ranges of personnel. For example, the optimization module 410 may determine a preferred range of personnel from different score ranges and/or rankings. The preferred range may be a combination of personnel to ensure beginner or novice personnel have the ability to learn from senior personnel. Additionally, the senior personnel may be adequately staffed to ensure the beginner or novice personnel receive adequate training while still achieving business goals.

The shift module 415 may create the shifts and compile a work schedule for the business. When creating the schedule, the shift module 415 may use the parameters module 405 and optimization module 410 to ensure the schedule created was optimized to meet the business needs. In some embodiments, the shift module 415 may additionally base the schedule off of personnel preferences. For example, personnel may have the ability to submit preferred shifts, preferred days off, preferred roles, and the like. The shift module 415 may consider the preferences when forming the shifts and overall work schedule. In some embodiments, preferential personnel (personnel with preferred scores) may receive their requests before other personnel. The shift module 415 may produce a work schedule for a predetermined time period. For example, the shift module 415 may produce a work schedule for a day, two days, a week, two weeks, etc. Once the shifts and schedules are created, the shift module 415 may send the schedule to a supervisor for approval.

The editing module 420 may enable the supervisor to edit and approve the work schedule created by the shift module 415. In further embodiments, any personnel associated with the business may edit and approve the work schedule. In some embodiments, the supervisor may manually make the changes to the schedule and approve it. In other embodiments, the supervisor may request the schedule module 320-a to redo the schedule based on certain parameters and/or feedback. If a business has multiple supervisors, the editing module 420 may enable the responsible supervisors to edit and review only their shifts. However, the schedule module 320-a may coordinate with other supervisors to ensure all staffing needs are met. Once all edits and approvals are received, the editing module 420 may produce a final work schedule. Conversely, the editing module 420 may relay information to the shift module 415, which may produce a final work schedule.

In some embodiments, a supervisor's actions may also be observed and recorded (by, for example, the observation module 305, FIG. 3). If supervisor shows preferential or discriminatory treatment of personnel, the supervisor may receive a warning. In some embodiments, these actions may cause the schedule module 320-a to alert the supervisor's supervisor concerning their actions.

Returning back to FIG. 3, the auxiliary module 325 may produce a list of auxiliary shift options. The auxiliary shift options may include at least a list of acceptable auxiliary personnel. The auxiliary personnel may be general auxiliary personnel or may be specific to particular roles and job functions of the personnel. In some embodiments, a scheduled personnel may have access to the list. For example, the auxiliary module 325 may publish and/or send the list to the scheduled personnel, supervisor, and the like. If a scheduled personnel is incapable of working, the personnel may contact an auxiliary personnel asking if they will work the upcoming shift. In some embodiments, the scheduled personnel and auxiliary personnel may interact using the personnel module 250 on the personnel devices 210. The auxiliary personnel may respond either affirmatively or negatively to the response. If the auxiliary personnel negatively responds, the scheduled personnel may continue polling the auxiliary personnel. Once an auxiliary personnel has positively responded, the substitute request may be sent for approval. In some embodiments, a supervisor may then have the option of approving or rejecting the request. If the request is approved, the schedule module 320 may receive a notification and update the schedule. If the request is rejected, the scheduled personnel may need to continue polling auxiliary personnel until an acceptable auxiliary personnel is located, confirmed, and approved.

In further embodiments, the list of shift auxiliary options may be published to a supervisor. The supervisor may access the auxiliary shift options to request personnel to work when the business experiences an increase in activity. For example, the business may have an increase in customers, sales, or other events that may require the need of additional personnel. The supervisor may use the list of auxiliary shift options to augment staffing to satisfy the business needs. In some embodiments, the supervisor may send a work request to the auxiliary personnel. For example, the supervisor may use the remote device 215 to send a request to the personnel device 210. The personnel may access the request using the personnel module 250 located within the personnel device 210. The personnel may then send a response back to the supervisor. The response may be positive or negative. If the response is negative, the supervisor may continue to contact auxiliary personnel until an auxiliary personnel affirmatively responds.

In some embodiments, the publication module 330 may publish a finalized and approved work schedule. If an auxiliary personnel has been requested to work, the publication module 330 may immediately update and publish the new schedule. The publication may be limited to supervisors, select personnel, or may be published and distributed to the business as a whole. In some embodiments, the schedule may be electronic and personnel may receive an email, text message, or the like containing the schedule. In other embodiments, personnel may access the schedule via the personnel module 250 on the personnel device 210 (FIG. 2). For example, the latest scheduling information may be accessible via a mobile application which may be downloaded to the personnel device 210.

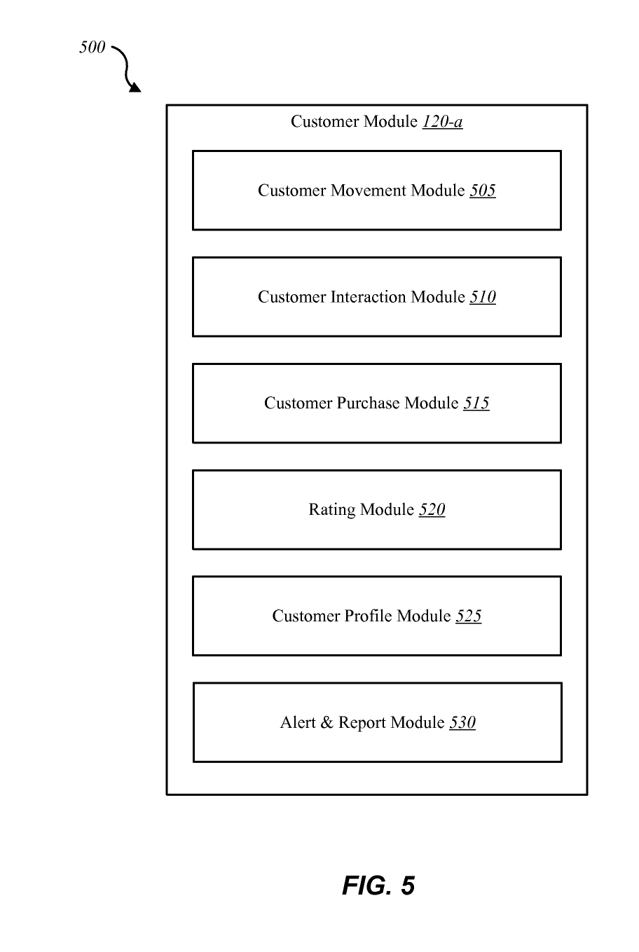

FIG. 5 is a is a block diagram 500 illustrating one example of a customer module 120-a. The customer module 120-a may be one example of the customer module 120 depicted in FIGS. 1 and/or 2. As depicted, the customer module 120-a may include a customer movement module 505, a customer interaction module 510, a customer purchase module 515, a rating module 520, a customer profile module 525, and an alert & report module 530. Other embodiments may include additional or, in some embodiments, fewer modules than that which is shown in FIG. 5.

In some embodiments, the customer movement module 505 may track, receive, and or record customer data. For example, the customer movement module 505 may be equipped to receive information regarding customer movement. The movement of customers may include when customers are entering or exiting a location associated with a business. In some embodiments, the customer movement module 505 may gauge a total length of time a particular customer was present at the business location. In other embodiments, the customer movement module 505 may track the movement of customers once they enter a location. For example, the customer movement module 505 may determine a number of customers present at the location and the location or movement of the customers within the location. For example, in some instances, a stream of customers may be entering the store and heading to a sale section, or only purchasing milk. The customer movement module 505 may track all this information.

In some embodiments, the customer movement module 505 may coordinate with an onsite security system or other such surveillance system. The customer movement module 505 may either use one or more cameras associated with the onsite system to track customer movement or may receive information from an onsite system relaying customer information. For example, the customer movement module 505 may capture the movement of a customer on a video feed. For example, the one or more cameras may be equipped to capture video of the customer and may track the customers throughout the location. In further embodiments, the onsite security system may also be equipped with door sensors, cameras, motion sensors, and/or the like. the customer movement module 505 may track a single customer throughout the store or may track multiple customers. In some embodiments, the tracking my occur simultaneously.

In some embodiments, the customer movement module 505 may compile information regarding the customer's visit to the business location. For example, the customer movement module 505 may edit the video feed to provide series of snap shots or video feeds of the customer throughout the store. In some embodiments, the customer movement module 505 may only display video feed when the customer is interacting with personnel associated with the business.

For example, the customer interaction module 510 may use the video data from the customer movement module 505 to determine when a customer is interacting with at least one personnel associated with the business. The interaction may be as simple as a greeting or may be more involved. For example, the customer may be at a clothing store and require help with selecting an outfit, finding a correct size, finding a particular product, using a changing room, and the like. The customer may ask the personnel for help or the personnel may help the customer check out. The customer interaction module 510 may track all these interactions using the video data from the customer movement module 505. In some embodiments, the customer interaction module 510 may also receive voice data. For example, one or more voice recorders may be used throughout the location. The customer interaction module 510 may use the voice feed and connect it to the video feed to create an overall portrait of the customer's interaction with at least one personnel associated with the business. In some embodiments, the personnel may be equipped with the recording device. In further embodiments, the video cameras may have a sound recording device, and in still further embodiments, sound recording devices may be distributed throughout the location and may be associated with an onsite security system. The customer interaction module 510 may couple the voice information with a video feed and provide an overview of the customer's interactions with at least one or more personnel associated with the business.

In further embodiments, the customer interaction module 510 may identify the customer, the personnel, and/or both. For example, the customer interaction module 510 may link the interaction to at least one personnel associated with the business. The customer interaction module 510 may identify the personnel and/or customer using voice recognition methods, facial recognition, and the like. In some embodiments, select personnel may be assigned to specific areas of the location which may aid the customer interaction module 510 in identifying the personnel. In additional embodiments, the personnel may greet the customer by name or the customer may identify themselves. In further embodiments, the customer may enter or use a unique identifier while present on the location which may aid the customer interaction module 510 with properly identifying the customer. In some embodiments, the customer is uniquely identified, such as via a unique identifier as mentioned. In further embodiments, the customer may be simply isolated to track their movements and purchases at a business location.

The customer purchase module 515 may track point of sale information. For example, the customer purchase module 515 may record data regarding customer's purchases including time of day, itemized purchases, correlation to events or sales, payment options, coupons, discounts, and the like. In some embodiments, the customer purchase module 515 may observe and determine whether the customer made a purchase and which items were purchased. In some embodiments, if a customer spent a specified amount of time in the store and did not make a purchase, an alert may be sent to a supervisor or other personnel. The customer purchase module 515 may correlate the purchases to determine a pattern of purchases. For example, the customer purchase module 515 may associate purchases with a unique identifier that uniquely identifies the customer. The customer purchase module 515 may track a history of purchases associated with the customer and determine if there is any pattern to them. In further embodiments, the customer purchase module 515 may correlate sales and purchases to specific personnel. For example, the customer may provide a name of a personnel who helped. In some embodiments, the customer purchase module 515 may receive personnel information from the customer interaction module 510 to correctly identify which personnel helped the customer.

The rating module 520 may gather all of the data and information from the customer movement module 505, the customer interaction module 510, and the customer purchase module 515 to provide one or more ratings. The ratings may provide an overall score for the customer interaction with one or more personnel. For example, the rating module 520 may review the information and determine, based on the data, that the customer had a positive experience and develop a positive rating. In other instances, the rating module 520 may determine the customer had a negative experience and issue a negative rating. The rating may be based at least in part on the amount of time the customer spent at the business, the items purchase, the interaction with the personnel, and the like. For example, the rating module 520 may link the purchases made by a customer with video of the customer. The rating may then be additionally based at least in part on the length of time the customer spent in the store and the purchases made.

In additional embodiments, the rating module 520 may provide a personnel rating. For example, the rating module 520 may receive information regarding a particular personnel's interaction with a customer. The rating module 520 may review the data to determine a rating. The rating may be based at least in part on the interaction between the personnel and the customer, the purchase made by the customer, and the like. In some embodiments, the interaction may have been negative. For example, the customer may become difficult to work with. In those embodiments, the rating module 520 may adjust the rating to quantify the professionalism of the personnel when faced with less than desirable conditions. In further embodiments, the personnel may have reacted unprofessionally to cause the negative situation. In those embodiments, the personnel may handle the altercation professionally but receive a negative rating due to their involvement. In some embodiments, the rating may be recorded in a profile associated with the personnel (e.g. personnel profile).

The ratings may be numeric or categorical. For example, the rating may consist of a numeric scale such as 1-10. The rating module 520 may scale the customer interaction rating and personnel rating along the same basis. In further embodiments, the rating may be categorical. Categories may include excellent, moderate, fair, poor, below average or the like. Any combination of categories may be used. In some embodiments, the personnel rating and the customer interaction rating may not align.

The customer profile module 525 may track, store, and organize all of the data relating to customer interactions. The customer profile module 525 may generically record customer information or may create profiles associated with individual customers. For example, a customer may have a unique identifier. The unique identifier may be one of a loyalty card number, a credit card number, a phone number, an email, a name, or the like. The customer profile module 525 may generate a profile associated with the customer based at least in part on the rating by the rating module 520 and the unique identifier. In some embodiments, the customer profile may be located in a database (e.g. customer data 255). In further embodiments, purchase information, video information, and the like may also be stored in the customer profile. In some embodiments, the customer profile module 525 may determine trends. The trends may result in the customer profile module 525 developing and generating marketing material based on the trends.

The alert & report module 530 may facilitate alerts based on the above described modules and parameters. For example, the alert & report module 530 may generate and push alerts to various personnel including supervisors. The alert & report module 530 may send an alert to a personnel or supervisor when the personnel rating does not meet a threshold. For example, the personnel may have received a subpar rating from the rating module 520. The alert & report module 530 may send an alert notifying the personnel's supervisor. The supervisor or other personnel may also receive an alert when a customer interaction rating falls below a predetermined standard. The supervisor may receive alerts on a computing device (e.g. mobile computing device 225), a remote device (e.g. remote device 215) or the like. The alerts may be one of a ping message, SMS, alert, voice message or the like.

The alert & report module 530 may also allow the supervisor to view the data on a dashboard. For example, the supervisor may access a user interface associated with the business. The user interface may be accessed from a computing device (e.g. mobile computing device 225), a mobile device (e.g. remote device 215), or the like. The dashboard may present the data as customer interaction clips. This may allow the supervisor to review the exchanges and interchanges that resulted in the subpar rating. In further embodiments, the alert & report module 530 may allow the supervisor to view any customer interaction or exchanges via the dashboard. For example, the supervisor may view exchanges at the front desk of a hotel, at the changing rooms of a retail store, at the hostess station of a restaurant, and the like. The supervisor may select which video feeds to view. In still further embodiments, the alert & report module 530 may allow the supervisor to view live feeds of customers at the business.

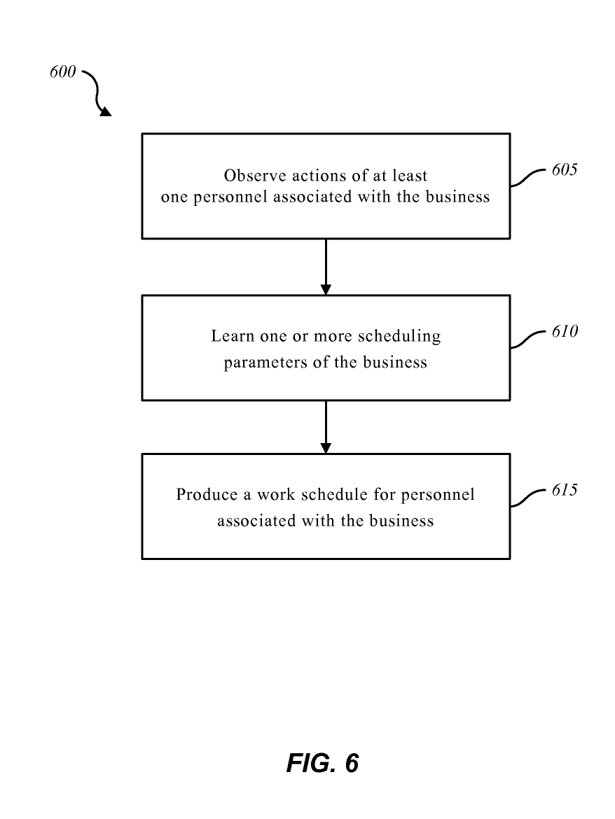

FIG. 6 is a flow diagram illustrating one embodiment of automating work schedule for a business. In some configurations, the method 600 may be implemented by the automated schedule module 110 of the location system 105 shown in FIGS. 1 and/or 2. In other examples, the method 600 may be performed generally by the location system 105 shown in FIGS. 1 and/or 2, or even more generally by the environments 100, 200 shown in FIGS. 1 and/or 2.

At block 605, actions of at least one personnel associated with the business may be observed. For example, one or more personnel may be observed based on their performance, timeliness, reliability and the like. The personnel's arrival and departure times or clock-in and clock-out times may be compared to the scheduled time to determine if the personnel is consistently punctual or tardy. Additionally, the personnel's absences may be observed as well as whether the personnel gave adequate notice for the pending absences. If a particular personnel consistently calls in sick right before their shift starts, the personnel may be flagged as unreliable. In contrast, if a personnel is usually on time for their shift but occasionally gives adequate notice prior to absences, the personnel may be seen as reliable.

In some embodiments, historical information regarding the business may also be observed. For example, seasonal information, market information or previous sales information may be gathered and stored. The information may provide an insight into the functions and fluctuations of the business to provide more well-rounded knowledge. In some embodiments, historical scheduling information may also be observed. For example, historical or previous scheduling information may be input into the system. The historical information may speed up the observation process to provide an automated schedule system. The historical information may reduce the observation and learning period to achieve an automated scheduling system sooner.

In some embodiments, the scheduled personnel and scheduling may be compared to the business metrics. For example, the impact of the personnel, their interaction and scheduling may affect business metrics such as efficiency, profit, waste, sales royalties, customer loyalty, overhead, loss, hours worked per process, and the like. Other aspects of the business may also be observed and recorded. For example, if weather affects the business, severe weather conditions may be tracked such as severe thunderstorms, snowstorms, tornadoes, earthquakes, etc. Additionally, newsworthy events may be observed and recorded if they may impact the particular business. For example, an e. coli outbreak in beef products may impact other producers of unaffected beef may still be negatively impacted by the news. All these type of external events that have the potential to negatively or positively impact the business may be observed and recorded.

At block 610, one or more scheduling parameters of the business may be learned. This may be based on the observations gathered at block 605. For example, all of the observations concerning personnel actions and scheduling may be compared to business metrics and external events to improve scheduling to positively impact the business. For example, a specific number of personnel may result in positive business metrics and reduce waste or loss. The specific number may be a combination of different personnel roles. In some embodiments, a scheduled mixture of personnel expertise may also benefit the business. The mixture of expertise may result in lower overhead costs while still achieving business goals. Additionally, the timing of shift changes or shift overlap may also benefit the business.

At block 615, a work schedule for personnel associated with the business may be produced. The schedule may be based on the learning at block 610 and/or the observations at block 605. The schedule may include a predetermined time period. For example, the schedule may be for the next day, week, two weeks, month, etc. The predetermined time period may be set by the supervisor, other personnel, or, in some embodiments, if no time period is set, it may default to two weeks.

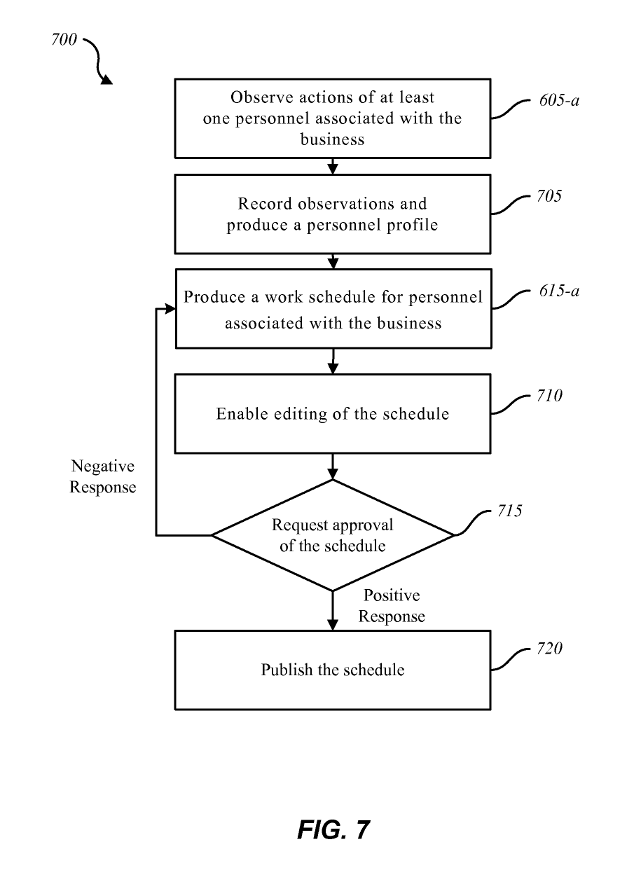

FIG. 7 is a flow diagram illustrating an embodiment of another method 700 for automating personnel scheduling. In some configurations, the method 700 may be implemented by the automated schedule module 110 of the location system 105 shown in FIGS. 1 and/or 2. In other examples, the method 700 may be performed generally by the location system 105 shown in FIGS. 1 and/or 2. Even still more generally, the method 700 may be performed generally by the environments 100, 200 shown in FIGS. 1 and/or 2.

At block 605-a, the personnel actions and scheduling may be observed. Then, at block 705, the observations may be recorded and personnel profile may be produced. For example, in some embodiments, the observations may be used to generate a personnel profile. The personnel profile may include the personnel's contact information, role, experience, number of sick days taken, number of vacations taken, achieved skill levels, pay-scale, and the like. In some embodiments, the personnel profile may also include a personnel score. For example, the personnel may have a rating based on their performance among other factors. The rating may reflect amount of experience, skills, absences, efficiency, or some combination thereof. The rating may also reflect additional information relevant to the personnel's performance or pay-scale. Each factor may have an individual factor score or rating. The factor score may be summed up to a total score, or may be averaged into an overall score. For some business, the score may be a numeric score. It may be on a small scale, such as 1-10, or may be on a much higher scale such as 1-100. In other embodiments, the rating may be a series of named levels such as beginner, novice, intermediate, advanced, and expert. Different scoring methods may be available. In some embodiments, the scoring methods may be unique and customized to particular businesses.

At block 615-a, a work schedule for personnel associated with the business may be produced. The schedule may be based upon the personnel score. For example, personnel with preferential scores may receive more desirable shifts, working hours, or vacation days. In some embodiments, the schedule may contain shifts with personnel of predetermined skill levels. For example, the shift may include five personnel, and at least one personnel may be from the “expert” range, and only one personnel may be from the “beginner” range. By varying the expertise and/or rating of the personnel, the schedule may maximize business metrics and personnel learning. For example, the schedule may balance the expertise and/or ranking of the personnel with the pay-scale associated with the personnel to maximize for business profit. Additionally, by using the different rankings and ratings, the schedule may prevent scheduling multiple unreliable personnel for the same shift. This may prevent an understaffed shift due to multiple absences. In some embodiments, a supervisor or other personnel associated with the business may set the personnel score distribution or requirements for each shift.

At block 710, the schedule may be edited. For example, the schedule created at block 615-a may be published only to select personnel such as a supervisor. The supervisor may have the ability to change aspects of the schedule. In some embodiments, any aspect of the schedule may be changed or edited. For example, staffing for shifts may be increased or decreased. The timing of shifts or the personnel scheduled may be changed. In some embodiments, no changes may be necessary.

Once the editing is complete, at block 715, the approval of the schedule may be requested. If the schedule is rejected, a new schedule may be created at block 615-a. For example, the schedule may be rejected and a request for a new schedule may be generated. In other embodiments, the rejection may provide feedback as to why the schedule was rejected so a more desirable schedule can be produced. In some embodiments, an overall schedule change request or specific changes to the schedule may be requested. Changes may be observed and recorded as part of a learning module (e.g. learning module 310). In other embodiments, the changes may be requested due to pending events. For example, the business may have an upcoming event such as a party reservation at a restaurant, an increase in sales due to a convention or product release, or some other event. This feedback may be provided with the rejection and a new schedule may be generated at block 615-a.

If the schedule is approved, at block 720, the schedule may be published. For example, the schedule may be electronic and may be distributed to various business personnel. The schedule may be distributed via text message, email, online, and the like. In some embodiments, the schedule may be sent to a mobile device associated with the personnel (e.g., personnel device 210 and/or remote device 215). For example, the mobile device may have an application which may access the schedule. In further embodiments, a hard copy of the schedule may be created and distributed to personnel.

In some embodiments, other steps of method 700 may include portions of the method 600. In other embodiments, the method 700 may include receiving requesting time-off from personnel. For example, the personnel may submit requested vacation days or specific days off. The schedule may be additionally based on these personnel preferences.

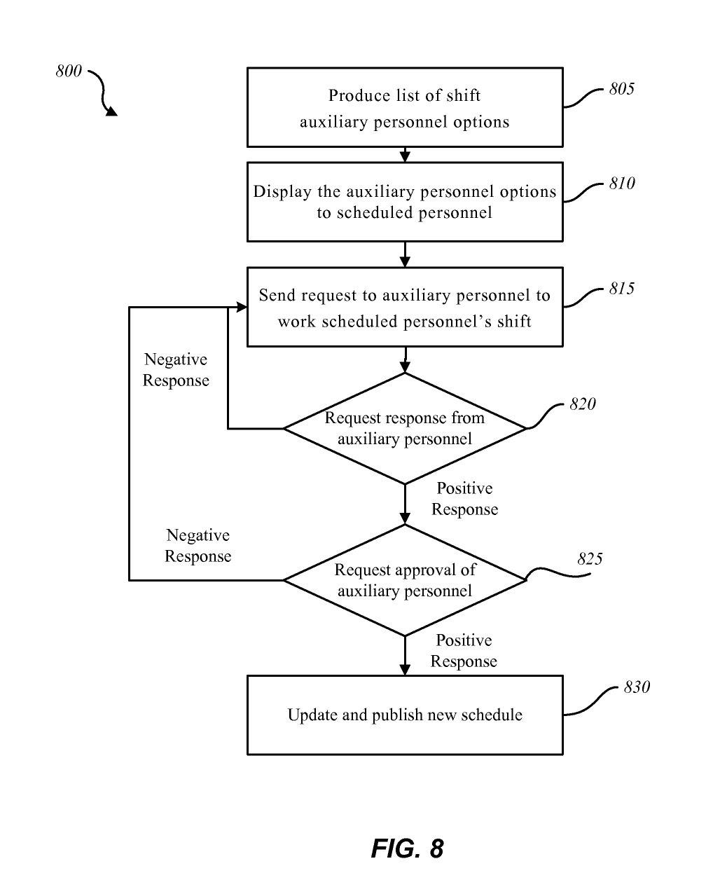

FIG. 8 is a flow diagram illustrating an embodiment of a method 800 for finding auxiliary personnel. In some configurations, the method 800 may be implemented by the automated schedule module 110 of the location system 105 shown in FIGS. 1 and/or 2. In other examples, the method 800 may be performed generally by the location system 105 shown in FIGS. 1 and/or 2. Even still more generally, the method 800 may be performed generally by the environments 100, 200 shown in FIGS. 1 and/or 2. In some embodiments, other steps of method 800 may include portions of the method 600 and/or 700.

At block 805, a list of shift auxiliary personnel options may be produced. For example, when the schedule is generated, certain personnel may not be scheduled to work but may be listed as available to work. The list of shift auxiliary personnel may include alternative personnel to replace a scheduled personnel. The list may be specific to personnel roles. For example, the list may be specific to cooks, wait staff, carpenters, electricians, etc. Each role within a business may be defined and the list may include alternative personnel for each shift. In some embodiments, the lists may only contain desirable personnel. For example, if personnel have a score associated with them, the list may only comprise personnel who have achieved and/or maintained a certain score or proficiency level or surpassed a threshold. In still further embodiments, the list of auxiliary personnel may be specific to the scheduled personnel. For example, the list may only contain alternative personnel with the same ranking and/or proficiency level with the same personnel role. Additionally, the list may be specific for the shift or may be a generic auxiliary list for any timeframe. In some embodiments, if the list is a generic list, personnel may need to achieve a predetermined proficiency level or score in order to join the list.

At block 810, the auxiliary personnel options may be displayed to the scheduled personnel. For example, the list may be electronic and may be distributed to scheduled personnel. If the list is a generic list, it may be generally distributed and always available. The electronic list may be distributed and/or available via email, online, or via a mobile phone. For example, an application downloaded onto a mobile device may access the list of auxiliary personnel. In other embodiments, the list may be printed and available in a hardcopy. The hardcopy may be displayed onsite at the business, or may be distributed among personnel.

At block 815, if a personnel has a conflict and cannot work, the personnel may send a request to an auxiliary personnel to work the scheduled personnel's shift. For example, the scheduled personnel may be unable to work and may view the list of auxiliary personnel. The scheduled personnel may contact auxiliary personnel and ask the auxiliary personnel to fill in. The request may be sent via the mobile application on the personnel's mobile devices, or may be sent via other means such as a phone call, email, SMS, or the like. At block 820, a response from the auxiliary personnel may be requested. If the auxiliary personnel provides a negative response, at block 815, the scheduled personnel may start the process over.

However, if the auxiliary personnel provides a positive response, at block 825, an approval for the auxiliary personnel may be requested. For example, an approval request may be sent to a supervisor of the scheduled personnel. If the auxiliary personnel is not approved, the scheduled personnel may need to start the process over at block 815. For example, the auxiliary personnel may not have the same proficiency level or skillset as the scheduled personnel. The auxiliary personnel may also extend into overtime pay, which may cause the rejection of the auxiliary personnel. Other reasons for rejecting the request may also exist. Feedback may be provided to enable the scheduled personnel to find a better suited auxiliary. If the request is approved, at block 830, the schedule may be updated and a new schedule may be published.

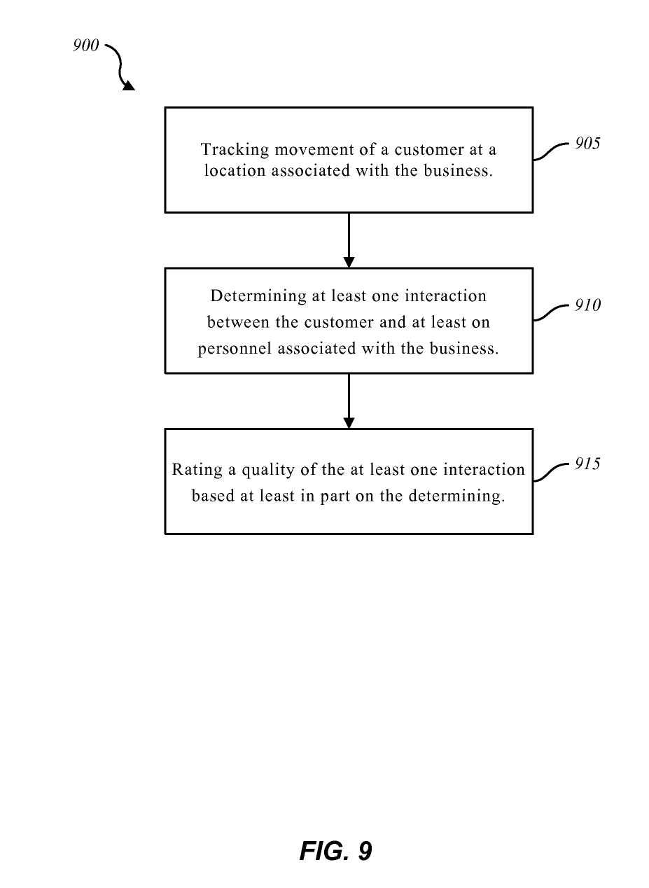

FIG. 9 is a flow diagram illustrating an embodiment of a method 900 for tracking customer interactions for a business. In some configurations, the method 900 may be implemented by the customer module 120 of the location system 105 shown in FIGS. 1 and/or 2. In other examples, the method 900 may be performed generally by the location system 105 shown in FIGS. 1 and/or 2. Even still more generally, the method 900 may be performed generally by the environments 100, 200 shown in FIGS. 1 and/or 2. In some embodiments, other steps of method 900 may include portions of the methods 600, 700, and/or 800.

At block 905, customer movement related to the business may be observed. The customer movement may comprise times when the customer entered and exited the building. The movement may also include tracking the customer throughout the store. In some embodiments, the tracking may capture one or more interactions with one or more personnel associated with the business. For example, the movement of customers may be observed via one or more cameras present at a location. The cameras may be video cameras. The cameras may track the location of the customer throughout the business and capture images of the customer while present at the business. In some embodiments, the business may have one or more audio-capturing devices present at the business. The audio-capturing devices may capture one or audio signals or conversations between a customer and one or more personnel. The audio data and image data may be linked to create a snapshot of the customer's presence at the business location.

At block 910, at least one interaction between the customer and at least one personnel associated with the business may be determined based on the tracking. For example, the tracking may have captured the customer interacting with one or more personnel associated with the business. The interaction may have comprised a simple greeting or exchange, or may have been more in depth. For example, the personnel may have aided the client in finding a particular product, shoe size, article of clothing, dinner menu, and the like. In other embodiments, the personnel may have been unhelpful and/or unkind to the customer.

At block 915, the quality of the at least one interaction may be rated based at least in part on the determining. For example, the interaction may have resulted in a positive interchange and the overall experience may receive a positive rating. The rating may be numeric or may be categorical. A customer may have multiple interaction ratings if the customer interacts with multiple personnel. For example, a customer may interact with a first personnel and the exchange may receive a negative rating. The customer may then seek help from a second personnel and receive a positive rating. In some embodiments, each individual interaction may be rated. In further embodiments, the overall experience may be rated. For example, the scores may be averaged together or become an aggregate score. In further embodiments, the combination of exchanges may be given an overall rating.

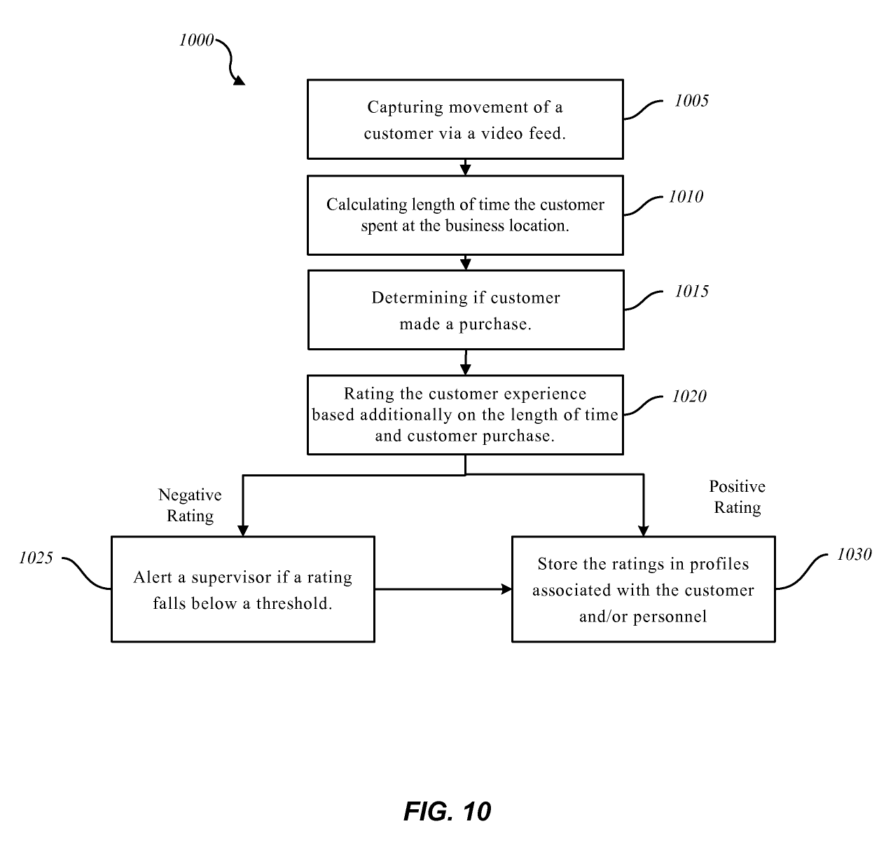

FIG. 10 is a flow diagram illustrating an embodiment of another method 1000 for tracking customer interactions for a business. In some configurations, the method 1000 may be implemented by the customer module 120 of the location system 105 shown in FIGS. 1 and/or 2. In other examples, the method 900 may be performed generally by the location system 105 shown in FIGS. 1 and/or 2. Even still more generally, the method 900 may be performed generally by the environments 100, 200 shown in FIGS. 1 and/or 2. In some embodiments, other steps of method 900 may include portions of the method 600, 700, 800, and/or 900.

At block 1005, movement of a customer may be captured via a video feed. For example, as stated previously, the business may have one or more cameras installed at a location associated with the business. The cameras may be equipped with video capturing abilities and may capture video of a customer as the customer travels throughout the location.

At block 1010, a total length of time the customer spent at the business location may be calculated. For example, an entry and exit time for the customer may be captured and recorded. The entry and exit time may be recorded via one of a motion sensor, camera, door sensor, or the like. Once the entry and exit times are recorded, a total length of time the customer spent at the location may be gauged or calculated.

At block 1015, it may be determined whether a customer made a purchase. It may further be determined which items or services were purchased and if they have any correlation to other purchases. For example, a store may track the purchases associated with a customer. The tracking may be accomplished via a unique identifier. The unique identifier may be one of a credit card number, loyalty card number, email, name, phone number or the like. It may be determined that the customer's purchases are all related. For example, the customer may be completing a home improvement project for a bathroom and may have a series of purchases relating to the project.

At block 1020, the customer experience may be rated based additionally on the length of time the customer spent at the store and the customer purchase. For example, the customer experience rating may be based at least in part on an interaction with personnel. In some embodiments, the rating may be additionally based on length of time and customer purchase. For example, the customer may have spent very little time in the store and not made any purchases. The overall customer experience rating may be low. However, a customer may spend an extended amount of time in a store and make a large purchase but have negative interactions with personnel. All of these varying factors may be used to determine a rating. In some embodiments, at block 1020, the personnel may also receive a rating based on their interaction with the customer. The rating may also factor in the same factors or additional or varying combinations of factors.

At block 1025, if the rating is negative or falls below a threshold, a supervisor may be alerted. The rating may be a customer interaction rating or a personnel rating. The threshold may be a minimum expected rating from every personnel or customer interaction. The rating may be immediate and cause the supervisor to take action to rectify a poor situation or replace a lackluster employee. The alert may be sent to a mobile device (e.g. remote device 215) associated with a supervisor. The supervisor may be a supervisor of the personnel.

At block 1030, if the rating is positive or above a threshold, the rating may be stored in profiles associated with the customer and/or personnel. Additionally, negative ratings may be stored in profiles associated with the customer and/or personnel after a supervisor has been alerted. In some embodiments, the supervisor may review the exchange and approve the unfavorable rating before it is stored in a profile. The review and approval may prevent inaccurate ratings from being recorded. This may be especially helpful during personnel review periods where negative ratings could potentially harm a personnel.

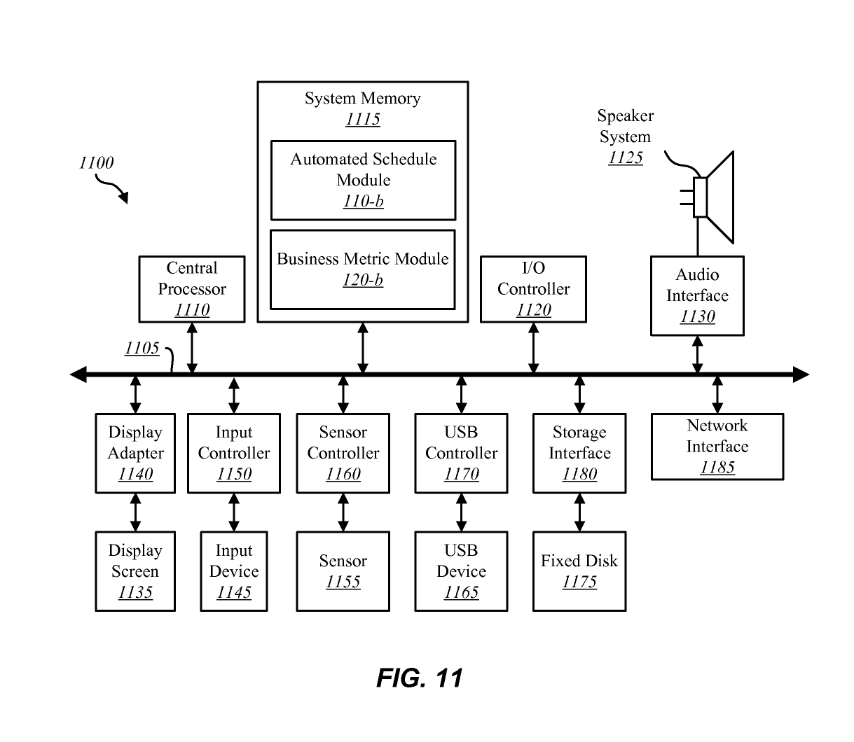

FIG. 11 depicts a block diagram of a computer system 1100 suitable for implementing the present systems and methods. The computer system 1100 may be an example of the mobile computing device 225, the remote device 215, the personnel device 210, the database 220, and/or some combination thereof illustrated in FIG. 2. In one configuration, the computer system 1100 may include a bus 1105 which interconnects major subsystems of the computer system 1100, such as a central processor 1110, a system memory 1115 (typically RAM, but which may also include ROM, flash RAM, or the like), an input/output controller 1120, an external audio device, such as a speaker system 1125 via an audio output interface 1130, an external device, such as a display screen 1135 via display adapter 1140, an input device 1145 (e.g., remote control device interfaced with an input controller 1150), multiple USB devices 1165 (interfaced with a USB controller 1170), and a storage interface 1180. Also included are at least one sensor 1155 connected to bus 1105 through a sensor controller 1160 and a network interface 1185 (coupled directly to bus 1105).

The bus 1105 may allow data communication between the central processor 1110 and the system memory 1115, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, an automated schedule module 110-b and/or a customer module 120-b to implement the present systems and methods may be stored within the system memory 1115. Applications (e.g., application 230) resident with the computer system 1100 are generally stored on and accessed via a non-transitory computer readable medium, such as a hard disk drive (e.g., fixed disk drive 1175) or other storage medium. Additionally, applications can be in the form of electronic signals modulated in accordance with the application and data communication technology when accessed via the network interface 1185.

The storage interface 1180, as with the other storage interfaces of the computer system 1100, can connect to a standard computer readable medium for storage and/or retrieval of information, such as a fixed disk drive 1175. The fixed disk drive 1175 may be a part of the computer system 1100 or may be separate and accessed through other interface systems. The network interface 1185 may provide a direct connection to a remote server via a direct network link to the Internet via a POP (point of presence). The network interface 1185 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., documents scanners, digital cameras, and so on). Conversely, all of the devices shown in FIG. 11 need not be present to practice the present systems and methods. The devices and subsystems can be interconnected in different ways from that shown in FIG. 11. The aspect of some operations of a system such as that shown in FIG. 11 are readily known in the art and are not discussed in detail in this application. Code to implement the present disclosure can be stored in a non-transitory computer-readable medium such as one or more of system memory 1115 or fixed disk drive 1175. The operating system provided on the computer system 1100 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method to track customer interactions for a business, comprising:
tracking movement of a customer at a location associated with the business;
determining at least one interaction between the customer and at least one personnel associated with the business based at least in part on the tracking; and
rating a quality of the at least one interaction based at least in part on the determining.

2. The computer-implemented method of claim 1, further comprising
identifying the at least one personnel interacting with the customer based on the determining; and
rating the at least one personnel based on the quality of the at least one interaction between the at least one personnel and the customer.

3. The computer-implemented method of claim 2, further comprising:
alerting a supervisor of the personnel when the personnel rating does not meet a threshold.

4. The computer-implemented method of claim 1, wherein the customer requests help from the at least one personnel.

5. The computer-implemented method of claim 1, wherein the at least one personnel completes a customer purchase.

6. The computer-implemented method of claim 1, further comprising:
capturing the movement of the customer via a video feed;
determining the customer enter and exit times at the location associated with the business based at least in part on the capturing; and
calculating a total length of time the customer was present at the business location.

7. The computer-implemented method of claim 6, further comprising:
determining if the customer made a purchase;
linking the customer purchase to a video of the customer;
rating the customer experience additionally based at least in part on the total length of time the customer was at the business location and the customer purchase.

8. The computer-implemented method of claim 6, further comprising:
displaying the video feed on a dashboard associated with the business, wherein the dashboard is accessible via a mobile computing device.

9. The computer-implemented method of claim 1, further comprising:
assigning the customer a unique identifier;
recording the rating associated with the customer based on the unique identifier; and
generating a profile associated with the customer based at least in part on the rating and unique identifier.

10. The computer-implemented method of claim 9, wherein the unique identifier is one of a loyalty card number, a credit card number, a phone number, an email, or a name.

11. The computer-implemented method of claim 9, furthering comprising:
observing purchases made by the customer;
recording the observed purchases associated with the customer based on the unique identifier; and
generating marketing material unique to the customer based on the recording.

12. The computer-implemented method of claim 1, further comprising:
notifying at least one personnel associated with the business when a customer interaction rating falls below a threshold.

13. An apparatus to track customer interactions for a business, comprising:
a processor;
a memory in electronic communication with the processor; and
instructions stored in the memory, the instructions being executable by the processor to:
track movement of a customer at a location associated with the business;
determine at least one interaction between the customer and at least one personnel associated with the business based at least in part on the tracking; and
rate a quality of the at least one interaction based at least in part on the determining.

14. The apparatus of claim 13, wherein the instructions are executable by the processor to:
identify the at least one personnel interacting with the customer based on the determining; and
rate the at least one personnel based at least in part on the quality of the at least one interaction between the at least one personnel and the customer.

15. The computer-implemented method of claim 13, wherein the instructions are executable by the processor to:
assign the customer a unique identifier;
record the rating associated with the customer based on the unique identifier; and
generate a profile associated with the customer based at least in part on the rating and unique identifier.

16. The apparatus of claim 13, wherein the instructions are executable by the processor to:
identify an unpredicted change in customer data, wherein the changes comprise one of unpredicted fluctuation in customer traffic or unpredicted fluctuation in customer purchases;
request information from at least one personnel associated with the business to correlate the unpredicted change in customer data with an external event; and
record the unpredicted change in a database with correlating external event information.

17. The apparatus of claim 13, wherein the instructions are executable by the processor to:
producing a list of shift auxiliary options, the shift auxiliary options comprises at least a list of acceptable auxiliary personnel;
displaying the options to a supervisor of the auxiliary personnel; and
receiving a notification that an acceptable auxiliary personnel agreed to work.

18. A computer-program product to track customer interactions for a business, the computer-program product comprising a non-transitory computer-readable medium storing instructions executable by a processor to:
track movement of a customer at a location associated with the business;
determine at least one interaction between the customer and at least one personnel associated with the business based at least in part on the tracking; and
rate a quality of the at least one interaction based at least in part on the determining.

19. The computer-program product of claim 18, wherein the instructions are executable by the processor to:
identify the at least one personnel interacting with the customer based on the determining; and
rate the at least one personnel based on at least in part on the quality of the at least one interaction between the at least one personnel and the customer.

20. The computer-program product of claim 18, wherein the instructions are executable by the processor to:
assign the customer a unique identifier;
record the rating associated with the customer based on the unique identifier; and
generate a profile associated with the customer based at least in part on the rating and unique identifier.
